(19) United States
(12) Patent Application Publication
(10) Pub. No.: US 2026/0257868 A1
(43) Pub. Date: Sep. 3, 2026

(54) TRANSPORT SYSTEM

(71) Applicant: WEISS GMBH, Buchen (Odw.) (DE)

(72) Inventors: Pawel DUDEK, Wieliczka (PL); Sebastian MATYS, Liszki (PL); Ralf STEINMANN, Obersulm (DE)

(21) Appl. No.: 18/994,464

(22) PCT Filed: May 24, 2024
(86) PCT No.: PCT/EP2024/064320

§ 371 Date: Jan. 14, 2025

(30) Foreign Application Priority Data
Jun. 9, 2023 (DE) 102023115153.3

(51) Int. Cl. B65G 21/22; B65G 54/02; H02K 41/02

(52) U.S. Cl. CPC B65G 21/22; B65G 54/02; H02K 41/02

(57) ABSTRACT

The invention relates to a transport system for transporting objects, said transport system comprising a transport rail, which has at least a first running surface and a second running surface that are arranged disposed opposite one another, and at least one transport trolley. The transport trolley comprises a base body that is coupled or can be coupled to an object carrier for receiving at least one object to be transported, a first roller rotatably supported about a first axis of rotation and a second roller rotatably supported about a second axis of rotation, wherein the first and the second roller are arranged at the base body such that the first and the second axis of rotation are stationary relative to the base body and such that they cooperate with the first running surface, and a third roller that is rotatably supported about a third axis of rotation and that is arranged at a pivot arm that is pivotably arranged at the base body about a pivot axis. The pivot arm can be acted on by a preloading force, by which the third roller is pressed against the second running surface, by a preloading device acting between the base body and a contact point of the pivot arm. The third axis of rotation, the pivot axis and the contact point lie on a straight line.

The invention relates to a transport system for transporting objects along a transport rail.

Transport systems are, for example, used in automation technology to transport objects from one location to another location, for example, from a production station or processing station. For this purpose, the objects are positioned on transport trolleys and the transport trolleys are traveled along a rail. The rail can in this respect have straight and/or curved sections.

In practice, value is in particular placed on the cornering ability of the system since systems that are not capable of cornering work discontinuously and their clock rates are limited. Furthermore, such transport systems should simultaneously have a high load-bearing capability and a good profile accuracy to be able to both transport large loads and ensure a high accuracy in the positioning of the transport trolleys and a low noise development during transport.

It is also of essential importance that the transport trolleys or the transport systems work reliably and are nevertheless inexpensive in the manufacture and the assembly.

It is therefore the object of the invention to provide a transport system that satisfies all of the above-mentioned requirements.

The object is satisfied by a transport system according to claim 1.

A transport system according to the invention comprises a transport rail having at least a first running surface and a second running surface that are arranged disposed opposite one another. Furthermore, the system has at least one transport trolley that comprises a base body that is coupled or can be coupled to an object carrier for receiving at least one object to be transported. The object carrier can also be integrally formed with the base body.

A plurality of transport trolleys are usually provided that are preferably individually controllable so that they can be moved independently of one another along the transport rail.

The transport trolley comprises at least a first roller rotatably supported about a first axis of rotation and at least a second roller rotatably supported about a second axis of rotation, wherein the first and the second roller are arranged at the base body such that the first and the second axis of rotation are stationary relative to the base body and such that they cooperate with the first running surface. It is conceivable that further stationary rollers are provided.

Furthermore, at least a third roller is provided that is rotatably supported about a third axis of rotation and that is arranged at a pivot arm that is pivotably arranged at the base body about a pivot axis. The pivot arm can be acted on by a preloading force, by which the third roller is pressed against the second running surface, by a preloading device acting between the base body and a contact point of the pivot arm. The third axis of rotation, the pivot axis and the contact point lie on a straight line.

Further rollers may be present that are arranged at a pivot arm of the above-described kind. A plurality of pivot arms can generally also be provided. Two or more rollers, but preferably exactly one roller, can be associated with one pivot arm.

The number of stationary rollers (but at least two) and the number of rollers arranged at a pivot arm can generally be selected as required, for example to be able to reliably absorb the loads occurring during the operation of the system.

In many systems, the width of the transport rail varies in its course. A change in the rail width can in particular occur in a transition from a straight transport section to a curved section with a constant radius. In this transition, the transport rail has a course that is described by one or more functions (e.g. polynomials) that are calculated as part of complex optimization processes. The two sides of the rail can be described by different functions so that their course is not necessarily parallel.

Due to the support of the third roller at the pivotable pivot arm, a distance between the third roller, on the one hand, and the first and the second roller, on the other hand, can be varied, while the distance between the first and the second roller is constant. The variations in the rail width and/or tolerances can be reliably absorbed by the non-stationary support of the third roller. It is ensured by the preloading force that the third roller is always pressed against the rail with a sufficiently large force. Ultimately, this has the result that the first and the second roller also have reliable contact with the transport rail. In this respect, the aim is that no slippage occurs between the rollers and the transport rail.

Due to the arrangement of the third axis of rotation, the pivot axis and the contact point on a straight line, a particularly compact and easy to manufacture and easy to assemble pivot arm can be provided that can be acted on by a sufficiently large preloading force without mechanisms of a complex design.

The term running surface is to be understood broadly in the context of the present invention. In addition to planar surfaces, it also includes surfaces with a more complex geometry. Such running surfaces can comprise partial surfaces that are arranged inclined with respect to one another, such as running surfaces with a wedge-shaped design in a cross-section.

Further embodiments of the invention are set forth in the claims, in the description and in the enclosed drawings.

According to one embodiment, the pivot axis is arranged between the third axis of rotation and the contact point. Or in other words: The pivot arm has a first and a second section that are connected to one another in the region of the pivot axis, wherein the pivot arm can be formed in one piece or in a multiple pieces. The contact point is associated with the first section; the third axis of rotation is associated with the second section.

A first distance between the pivot axis and the contact point and a second distance between the pivot axis and the third axis of rotation can be of equal magnitude. However, it is also possible to design the two distances differently in order to create a desired “transmission ratio”. By selecting suitable distances, the pivot angle generated by the preloading force or the force acting on the third roller can be adapted as required.

According to a further embodiment, an abutment device is provided by which a pivoting of the pivot arm can be limited, said pivoting acting against the preloading force. The abutment device is preferably adjustable to be able to adapt the transport trolley to the respective conditions present. The abutment device can comprise a screw. In a particularly simple embodiment of the abutment device, a free end of the screw forms the abutment for the pivot arm.

In principle, it is additionally or alternatively also conceivable to provide an abutment that limits the pivoting of the pivot arm in the other direction-i.e. in the direction of the preloading force.

The abutment device can cooperate with an abutment section that is provided at a section of the pivot arm that carries the third roller. For example, the abutment section is arranged at a projection that extends laterally from the pivot arm.

A distance between the first and the second axis of rotation can be greater than a distance between the first and the third axis of rotation and/or a distance between the second and the third axis of rotation if the abutment device limits the pivoting of the pivot arm and/or if the transport trolley is located in a straight section of the transport rail. Provision can be made that the third axis of rotation, viewed in the longitudinal direction of the transport rail, is arranged in a region around a middle of the distance between the first and the second axis of rotation. The size of the region depends on the geometric conditions and in particular on the design and arrangement of the pivot arm. For example, this region is approximately less than 20%, preferably less than 10%, of the distance between the first and the second axis of rotation.

Or, in other words: The third axis of rotation can be disposed in a region around a straight line that intersects a straight line, perpendicular at its center, that connects the first and the second axis of rotation.

A particularly compact design of the transport trolley results if the base body together with the pivot arm substantially has the basic shape of an isosceles triangle, in particular an equilateral triangle, in a plan view of a side facing away from the transport rail, wherein the axes of rotation of the rollers are arranged in the region of the apexes of the triangle so that the axes of rotation likewise form an isosceles triangle, in particular an equilateral triangle. However, it is also conceivable that the basic shape and the arrangement of the axes of rotation do not have a similar geometric shape. The choice of the basic shape of the base body and the arrangement of the axes of rotation can be optimized for the respective application.

If, for example, two stationary rollers and two rollers are provided that are each arranged at a pivot arm, their axis of rotation can be arranged such that they form a quadrangle (e.g. a square, a rectangle or a trapezoid) if the abutment device limits the pivoting of the pivot arms and/or if the transport trolley is located in a straight section of the transport rail.

According to one embodiment example, the base body has a recess in the region of one of the apexes of the triangle, in which recess a section of the pivot arm is movably arranged. The other two apexes of the triangle are formed by the base body.

The base body can define a plane from which at least one carrier section extends, said carrier section carrying at least a fourth roller that is rotatably supported about a fourth axis of rotation and that cooperates with a third running surface that is formed at a support rail spaced apart from the transport rail. The carrier section in particular extends perpendicular from the base body.

The fourth axis of rotation can be arranged parallel to the first, second and/or third axis of rotation. The fourth roller can be arranged at a free end of the carrier section. It can have a smaller diameter than the first, second and/or third roller. The first, second and/or third roller are preferably identical parts.

The fourth axis of rotation can be disposed approximately in the middle between the first and the second axis of rotation. It in particular lies on a straight line that connects the first and the second axis of rotation.

The fourth roller in particular serves to absorb tilting moments and/or other loads acting on the transport trolley.

According to various embodiments, the first roller, the second roller, the third roller and—if present—the fourth roller are not drive rollers. This means that the drive of the transport trolley does not take place via the rollers but by means of a separate drive device. Such a drive device can be a linear motor. The transport rail can be assigned a plurality of stator units (comprising e.g. coil arrangements) that are arranged behind one another in the transport direction and that, together with a runner unit (comprising e.g. a permanent magnet arrangement) arranged at the at least one transport trolley, form such a linear motor by means of which the at least one transport trolley can be moved along the transport rail.

The runner unit is in particular arranged at the carrier section. For example, the runner unit is arranged between the base body and the fourth roller. In this configuration, the fourth roller can advantageously help to absorb the magnetic forces occurring between the runner unit and the stator units.

According to a further embodiment, the preloading device comprises an elastic element, in particular a helical spring. An abutment device can be provided for the elastic element and can be adjusted to be able to vary the preloading force. This makes it possible to adapt the properties of the transport trolley to the respective conditions present.

To protect the elastic element, it can be at least sectionally arranged in a bore of the base body. For example, a passage is provided in which a helical spring providing the preloading force is largely arranged.

The present invention will be explained in the following purely by way of example with reference to advantageous embodiments and to the enclosed drawings. There are shown:

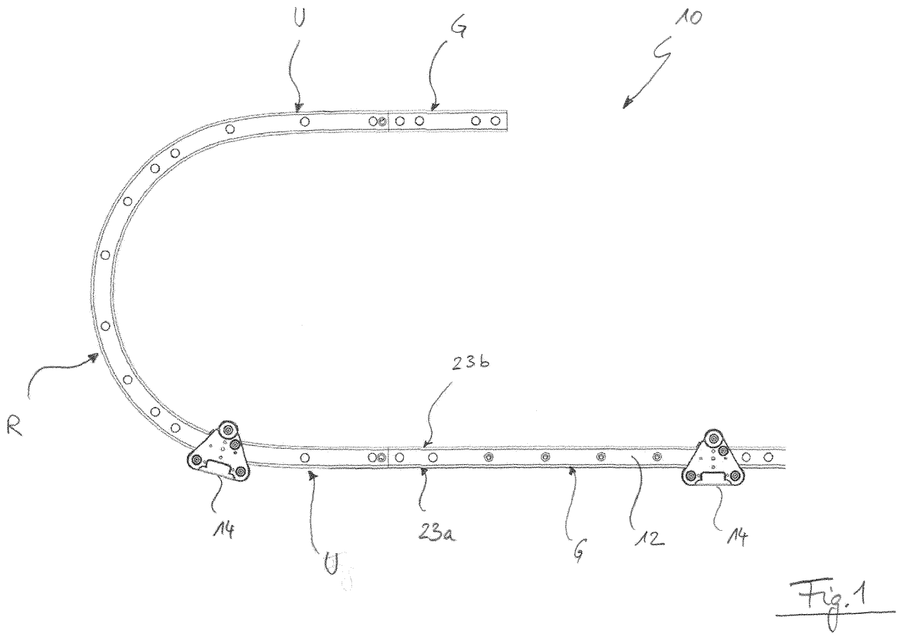

FIG. 1 a plan view of a part of a transport system (simplified view);

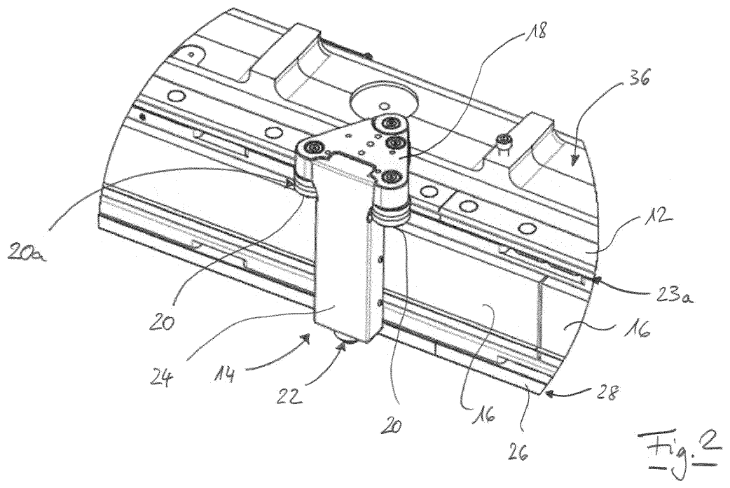

FIG. 2 a perspective view of a section of the transport system;

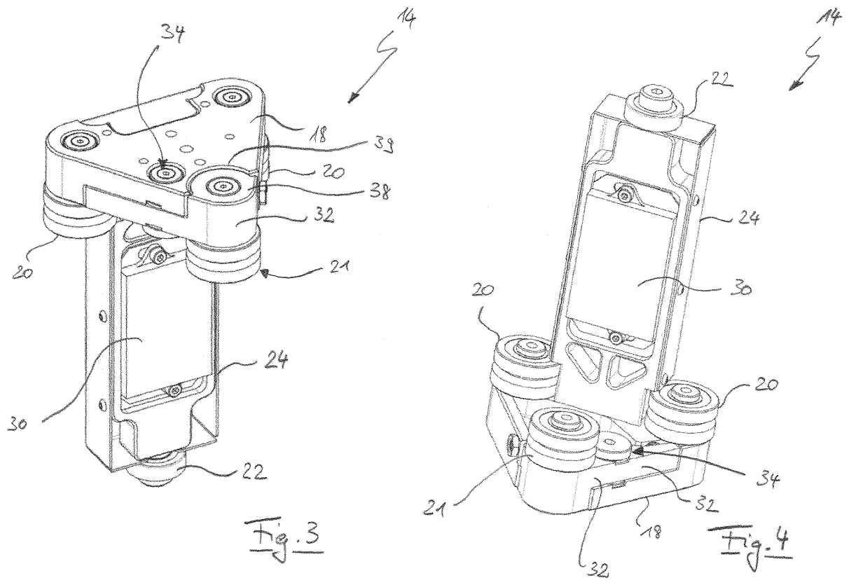

FIGS. 3, 4 different perspective views of a transport trolley;

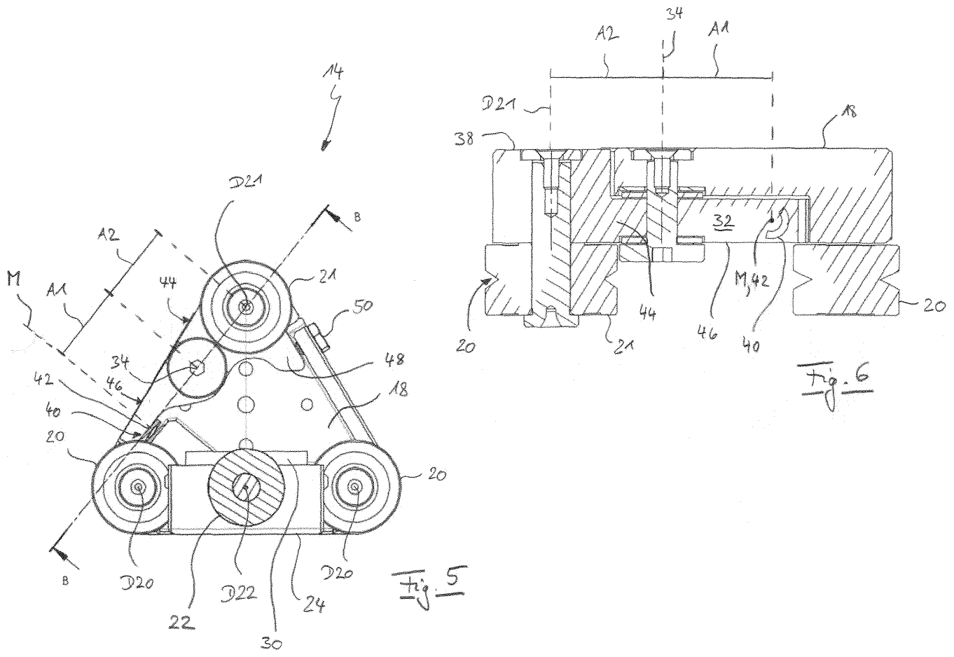

FIG. 5 a view of the transport trolley from below;

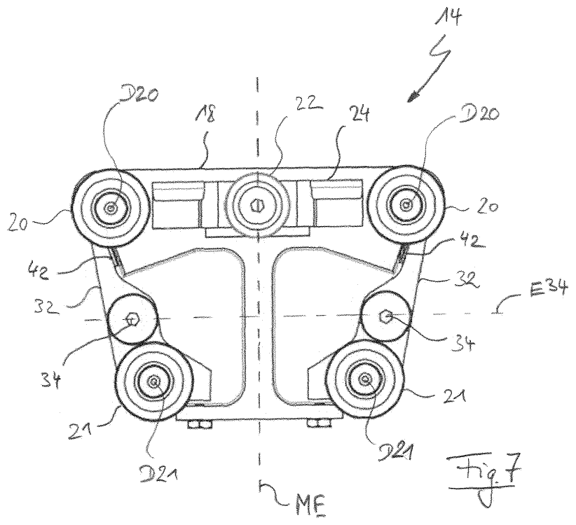

FIG. 6 a sectional view of the transport trolley along the line B-B (see FIG. 5);

FIG. 7 a view of a second embodiment of a transport trolley from below;

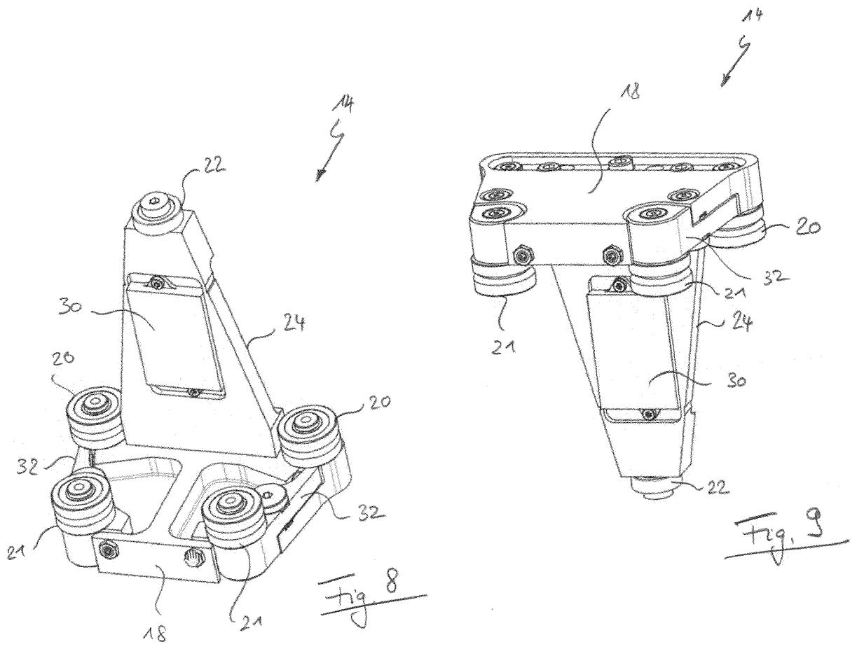

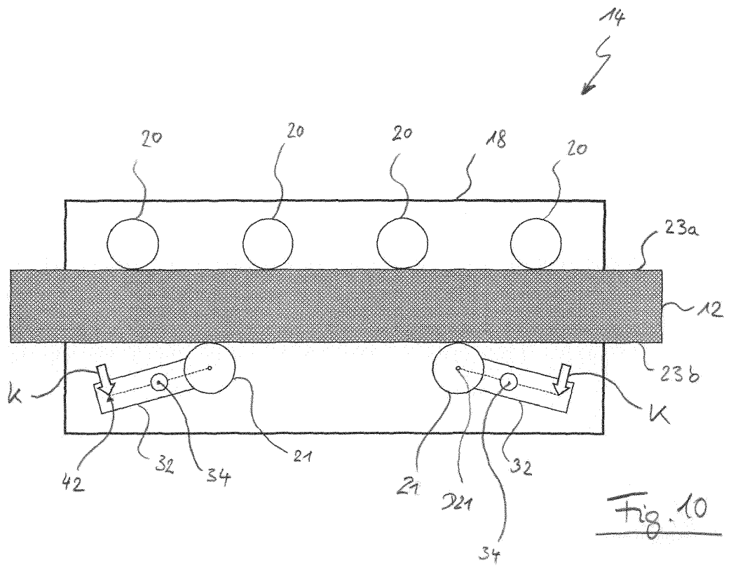

FIGS. 8, 9 different perspective views of the transport trolley in accordance with FIG. 7; and

FIG. 10 a third embodiment of a transport trolley.

A transport system 10 has a transport rail 12 comprising lateral running surfaces 23a, 23b along which transport trolleys 14 can be moved. For the sake of simplicity, the system 10 is only partly shown. Components not necessary for the understanding of the present invention have been omitted.

In the present embodiment example, the transport system 10 has sections G that have a straight transport path and that transition via transition sections U with a comparatively complex geometry into curved sections R that have a constant radius of curvature. It is understood that, unlike the example shown, transport rails can be realized with any desired path guidance.

Along the transport path defined by the transport rail 12, processing stations can, for example, be provided at which workpieces arranged on the transport trollies 14 are processed.

FIG. 2 shows a perspective view of a detail of the straight section G with a transport trolley 14. The drive of the transport trolley 14 takes place by a linear motor that has stator units 16 that are arranged behind one another in the longitudinal direction of the transport rail 12 and that cooperate with a runner unit (not visible) arranged at the transport trolley 14. The runner unit can comprise a permanent magnet arrangement. By controlling the units 16 accordingly, magnetic fields are generated that are variable in the transport direction and over time and that drive the trolley 14 to make a movement along the transport rail 12. Such linear motors are generally known.

The transport trolley 14 comprises a base body 18 at which two rollers 20 are supported. They are spatially fixed relative to the base body 18. The rollers 20 cooperate with the running surface 23a arranged at one side of the transport rail 12. The running surface 23a has a wedge shape in a cross-section, said wedge shape engaging into corresponding wedge grooves 20a of the rollers 20.

A further roller that cooperates with the running surface 23b is associated with the oppositely disposed side of the transport rail 12. However, it is not visible in FIG. 2. It is described with reference to FIGS. 3 to 6 below.

The above-described runner unit of the transport trolley 14 is arranged at a carrier section 24 that extends downwardly perpendicular from the base body 18. Due to the forces occurring between the runner unit and the stator units 16 during operation of the linear motor, tilting moments are produced that act on the base body 18 and on its guide at the transport rail 12. To absorb these tilting moments, a roller 22 is provided at the free end of the carrier section 24 and cooperates with a running surface 26 of a support rail 28. The axes of rotation of the rollers 20, 22 are arranged in parallel.

The stator units 16 are therefore disposed between the rails 12 and 28.

The support rail 28, the stator units 16 and the transport rail 12 are releasably fastened to a frame 36. It is understood that the structure can be modular so that individual modules with certain lengths and/or certain radii of curvature can be easily combined with one another to obtain a transport system with the desired configuration.

The arrangement and design of the roller 22 can be selected as required. It is possible, for example, to provide a roller 22 whose axis of rotation is oriented perpendicular to those of the rollers 20, for example to absorb vertically acting forces. It is also conceivable to provide a plurality of rollers 22 having axes of rotation that are aligned in parallel or differently oriented.

FIGS. 3 and 4 show different perspective views of the transport trolley 14 so that the runner unit can now also be seen (runner unit 30). The roller 22 can also be seen that, unlike the rollers 20, does not have a wedge groove 20a in the present embodiment example. Accordingly, the running surface 26 of the support rail 28 is planar.

In addition to the rollers 20, which are rotatably but spatially fixedly arranged at the base body 18, said base body carries a further roller 21 that cooperates with the running surface 23b of the transport rail 12 disposed opposite the running surface 23a. Unlike the rollers 20, however, the roller 21 is movable relative to the base body 18 since said roller 21 is mounted at a pivot arm 32 that is pivotably supported at the base body 18 by means of a pivot axis 34.

In a plan view, the base body 18 and a bearing section 38 of the pivot arm 32 carrying bearings of the roller 21 form a basic shape of an approximately equilateral triangle, which illustrates the compact design of the transport trolley 14. The base body 18 has a recess 39 to receive the section 38. In the present embodiment example, the surfaces of the base body 18 and of the section 38 lie substantially in one plane.

The design of the pivot arm 32 will be described in more detail below with reference to FIGS. 5 and 6.

FIG. 5 shows a view of the transport trolley 14 from below. The rollers 20 with their respective axes of rotation D20, which, for example, have a distance of 60 to 120 mm, are clearly visible. If necessary, a larger or smaller distance can also be considered. In the present embodiment example, this distance is greater than the distance of the axes of rotation D20 from an axis of rotation D21 of the roller 21 (during normal operation of the trolley 14). However, the geometric relationships can also be selected differently if required.

The axes of rotation D20, D22 lie on a straight line in the present example. However, this does not necessarily have to be the case since the rollers 20, 22 can have different diameters and/or the running surfaces 23a, 26—viewed in a direction parallel to the carrier section 24—can be arranged offset from one another. Viewed in the direction of the rail 12, the rollers 22 are disposed approximately in the middle between the rollers 20.

The axis of rotation D21 of the roller 21 can be pivoted relative to the base body 18 of the transport trolley 24, for example, to be able to absorb changes in the width of the transport rail 12 and/or tolerances. As already described above, the rollers 21 are arranged at the pivot arm 32. Said pivot arm is pivotable about the pivot axis 34.

To be able to press the roller 21 with a well-defined force against the running surface 23b assigned thereto and to thus ensure a reliable guidance of the transport trolley 14 at the transport rail 12 over the entire transport path, a preloading force, which is provided by a helical spring 40 arranged in a bore of the base body 18, acts on the pivot arm 32. Instead of the helical spring 40, any other elastic element that can apply the required force can be used. An adjustment mechanism (not shown) can be provided with which the preloading force can be adapted to the respective conditions present. For example, a contact position of the elastic element at the base body can be variable to be able to adjust the preloading force.

The helical spring 40 acts on the pivot arm 32 at a contact point 42. The contact point 42 is defined by the point of intersection of a center axis M of the helical spring 40 with a side surface of the arm 32 cooperating therewith. A distance A1 of the contact point 42 from the pivot axis 34 corresponds to a distance A2 of the axis of rotation D21 from the pivot axis 34. The distances A1, A2 can e.g. be in a range between 25 and 30 mm. However, the geometric relationships can also be selected differently if required. The distances A1 and A2 can in particular be selected with different magnitudes, e.g. to achieve a suitable “transmission” of the preloading force and/or to influence the pivot path.

The pivot axis 34 therefore functionally divides the pivot arm 32 into two sections, namely the roller section 44 carrying the roller 21 and the lever section 46 to which the preloading force is applied.

The roller section 44 has a laterally projecting abutment section 48 that cooperates with an abutment device 50 to limit the pivoting of the pivot arm 32 in a direction acting against the preloading force. In the present embodiment example, the abutment device 50 comprises a screw by means of which the abutment position can be easily adjusted.

FIG. 6 shows the transport trolley 14 in a sectional view in the sectional plane B-B drawn in FIG. 5 to illustrate the geometric relationships present. This sectional plane B-B includes the axis of rotation 21 as well as the pivot axis 34 and the contact point 42, i.e. the components mentioned lie-viewed in a plan view (see FIG. 5)—on a straight line.

FIG. 7 shows a further embodiment of the transport trolley 14 to illustrate that the number of rollers 21 is not limited.

The trolley 14 has two identically configured pivot arms 32 that each carry a roller 21. The transport trolley 14 described here as an example is designed mirror-symmetrically to a central plane ME. The axis of rotation D22 of the roller 22 lies in this plane ME.

In a well-defined state, for example when the transport trolley 14 is located in a straight section G of the transport rail 12, the axes of rotation D20 and D21 substantially form an isosceles trapezoid. The base body 18 likewise approximately reproduces the shape of an isosceles trapezoid.

The pivot axes 34 of the pivot arms 32 lie in a common plane E34. The pivot axes 34 also lie-as in the transport trolley in accordance with FIGS. 3 to 6—on a straight line R that is defined by the respective contact point 42 and the axis of rotation D21 of the corresponding arm 32.

In FIGS. 8 and 9, the transport trolley 14 of FIG. 7 is shown in different perspectives to illustrate its three-dimensional structure. Among other things, it can be seen that the carrier section 24-unlike the substantially rectangular carrier section 24 of the transport trolley in accordance with FIGS. 3 to 6—has a trapezoidal or triangular basic shape.

FIG. 10 shows a further transport trolley 14 having a rectangular base body 18 at which four rollers 20 are arranged in a fixed position. Said rollers cooperate with the running surface 23a of the transport rail 12. Two rollers 21, which are each arranged at a pivot arm 32, cooperate with the running surface 23b. The axes of rotation D21 of the rollers 21, the pivot axes 34 of the arms 32 and the contact points 42 at which the preloading force (symbolically represented by arrows K) acts, each lie on a straight line.

This embodiment of the transport trolley 14 is intended to illustrate that different numbers of rollers 20 fixedly arranged at the base body 18, on the one hand, and of rollers 21 pivotably arranged at the base body 18, on the other hand, can be provided.

Due to the concept according to the invention of providing a transport trolley having at least two fixed rollers and having at least one pivotable roller, which is carried by a pivot arm configured in the manner described above, it is possible to press the at least three rollers against the running surfaces of the transport rail with a constant force in each of the various operating states, and thus to ensure a reliable guidance of the trolley at the rail. The preloading force of the preloading device generating this force can, for example, be easily applied by a spring, in particular a helical spring, having a suitable spring constant and can, if necessary, be adapted using an optionally provided adjustment device.

### REFERENCE NUMERAL LIST

10 transport system
12 transport rail
14 transport trolley
16 stator unit
18 base body
20,21,22 roller
20a wedge groove
23a, 23b, 26 running surface
24 carrier section
28 support rail
30 runner unit
32 pivot arm
34 pivot axis
36 frame
38 bearing section
39 recess
40 helical spring
42 contact point
44 roller section
46 lever section
48 abutment section
50 abutment device
G straight section
U transition section
R curved section
D20, D21, D22 axis of rotation
A1, A2 distance
B-B sectional plane
M center axis
ME central plane
E34 pivot axis plane
K preloading force

1-16. (canceled)

17. A transport system for transporting objects, said transport system comprising a transport rail, which has at least a first running surface and a second running surface that are arranged disposed opposite one another, and at least one transport trolley comprising:
a base body that is coupled or can be coupled to an object carrier for receiving at least one object to be transported,
at least a first roller rotatably supported about a first axis of rotation and at least a second roller rotatably supported about a second axis of rotation, wherein the first and the second roller are arranged at the base body such that the first and the second axis of rotation are stationary relative to the base body and such that they cooperate with the first running surface,
at least a third roller that is rotatably supported about a third axis of rotation and that is arranged at a pivot arm that is pivotably arranged at the base body about a pivot axis,
wherein the pivot arm can be acted on by a preloading force, by which the third roller is pressed against the second running surface, by a preloading device acting between the base body and a contact point of the pivot arm, and
wherein the third axis of rotation, the pivot axis and the contact point lie on a straight line,
wherein the pivot axis is arranged between the third axis of rotation and the contact point.

18. The transport system according to claim 17,
wherein a first distance between the pivot axis and the contact point and a second distance between the pivot axis and the third axis of rotation are of equal magnitude.

19. The transport system according to claim 17,
wherein an abutment device is provided by which a pivoting of the pivot arm can be limited, said pivoting acting against the preloading force.

20. The transport system according to claim 19,
wherein the abutment device is adjustable.

21. The transport system according to claim 19,
wherein a section of the pivot arm that carries the third roller has an abutment section that cooperates with the abutment device to limit the pivoting of the pivot arm, said pivoting acting against the preloading device.

22. The transport system according to claim 17,
wherein a distance between the first and the second axis of rotation is greater than a distance between the first and the third axis of rotation and/or a distance between the second and the third axis of rotation when the abutment device limits the pivoting of the pivot arm and/or when the transport trolley is located in a straight section of the transport rail.

23. The transport system according to claim 17,
wherein the base body together with the pivot arm substantially has the basic shape of an isosceles triangle in a plan view of a side facing away from the transport rail, wherein the axes of rotation of the rollers are arranged in the region of the apexes of the triangle.

24. The transport system according to claim 17,
wherein the base body defines a plane from which at least one carrier section extends, said carrier section carrying at least a fourth roller that is rotatably supported about a fourth axis of rotation and that cooperates with a third running surface that is formed at a support rail spaced apart from the transport rail.

25. The transport system according to claim 24,
wherein the fourth axis of rotation is arranged parallel to the first, second and/or third axis of rotation and/or wherein the fourth roller is arranged at a free end of the carrier section.

26. The transport system according to claim 24,
wherein the fourth roller has a smaller diameter than the first, second and/or third roller.

27. The transport system according to claim 17,
wherein the first roller, the second roller, the third roller and—if present—the fourth roller are not drive rollers.

28. The transport system according to claim 27,
wherein the transport rail is assigned a plurality of stator units that are arranged behind one another in the transport direction and that, together with a runner unit arranged at the at least one transport trolley, form a linear motor by means of which the at least one transport trolley can be moved along the transport rail.

29. The transport system according to claim 28,
wherein the runner unit is arranged at the carrier section.

30. The transport system according to claim 17,
wherein the preloading device comprises an elastic element.

31. The transport system according to claim 30,
wherein the elastic element is at least sectionally arranged in a bore of the base body.

32. The transport system according to claim 20,
wherein the abutment device comprises a screw.

33. The transport system according to claim 23,
wherein the base body together with the pivot arm substantially has the basic shape of an equilateral triangle.

34. The transport system according to claim 24,
wherein the carrier section extends perpendicular from the base body.

35. The transport system according to claim 28,
wherein the runner unit is arranged between the base body and the fourth roller.

36. The transport system according to claim 30,
wherein the elastic element is a helical spring.

37. The transport system according to claim 30,
wherein an abutment device of the elastic element can be adjusted to be able to vary the preloading force.
